(19) United States
(12) Patent Application Publication
(10) Pub. No.: US 2005/0264112 A1
(43) Pub. Date: Dec. 1, 2005

(54) Hub unit for use in electrically movable wheels and vehicle comprising the hub unit

(75) Inventors: Tatsuaki Tanaka, Kasai-shi (JP); Kazuhiro Tomoshige, Kasai-shi (JP); Ryohei Adachi, Kanzaki-gun (JP)

Correspondence Address: ECKERT SEAMANS CHERIN & MELLOTT, 600 GRANT STREET, 44TH FLOOR, PITTSBURGH, PA, 15219, US

(73) Assignee: Sanyo Electric Co., Ltd., Osaka (JP)

(21) Appl. No.: 11/137,839

(22) Filed: May 25, 2005

(30) Foreign Application Priority Data
May 27, 2004 (JP) 2004-156969

(51) Int. Cl. H02K 7/06; H02P 15/00

(52) U.S. Cl. 310/75 C; 310/67 A; 310/83; 310/216

(57) ABSTRACT

A hub unit wherein the axis is prevented from deflecting for use in electrically assisted bicycles. A single fixing support shaft (57) has opposite ends projecting outward respectively from opposite ends of a hub (7) enclosing a motor (9) and a planetary gear reduction mechanism (6) therein and having inner teeth (66a) in mesh with planetary gears (65). The rotor (4) of the motor (9) has a tubular rotating shaft (44) rotatably fitted around the support shaft (57) and is therefore rotatable free of deflection of its axis relative to the support shaft (57). The hub unit is more simplified in construction and easier to assemble than the conventional hub unit wherein the rotating shaft of the rotor (4) is separate from the support shaft (57).

### FIELD OF THE INVENTION

The present invention relates to hub units for use in electrically movable wheels, and to electrically assisted bicycles, wheelchairs and like vehicles comprising the hub unit.

### BACKGROUND OF THE INVENTION

FIG. 8 shows an electrically movable wheel hub unit 2 for an electrically assisted bicycle.

The electrically movable wheel hub unit (hereinafter referred to as the “hub unit”) has a motor 9 comprising a stator 3 and a rotor 4, a planetary gear reduction mechanism 6 coupled to a rotor shaft 41 extending through an end plate 52 of a motor housing 5, a hub 7 enclosing the motor 9 and the reduction mechanism 6 therein and having inner teeth 66a in mesh with planetary gears 65, and fixing support shafts 57, 57a in alignment with the rotor shaft 41 and projecting outward respectively from an end plate 51 on one side of the motor housing 5 opposite to the reduction mechanism 6 and from a planetary gear support frame 61, the support shafts 57, 57a extending outward from the hub 7.

The support shafts 57, 57a are fixed to the front fork or rear fork of the bicycle, and the spokes (not shown) of the wheel are fitted into spoke attaching holes 74a in circumferential walls 74, 74 provided around the hub 7.

When windings 32 on the stator 3 are energized, the rotor 4 rotates. The rotation of the rotor 4 is transmitted to the hub 7 upon a speed reduction by the planetary gear reduction mechanism 6 to rotate the wheel of the bicycle.

In the case where a load not smaller than a specified value acts on the pedals of the bicycle when they are stepped on, the windings 32 of the stator 3 are energized, permitting the rider to run with ease even on slopes.

See, for example, JP-A No. 2002-514550.

In the case of the hub unit 2 described above, the two fixing support shafts 57, 57a, which are separate from the rotor shaft 41, are arranged in alignment with the rotator shaft 41, so that the hub unit is complex in construction and requires much labor and time for assembling. Furthermore, the three shafts 41, 57, 57a are likely to be out of alignment owing to errors involved in machining or assembling the components, permitting their axes to deflect relative to one another.

The present invention provides a hub unit wherein only one fixing support shaft 57 is provided, the support shaft 57 having at least one end projecting outward from a hub 7, and a rotor 4 has a tubular rotating shaft 44 rotatably fitted around the support shaft 57, the hub unit thus being made free of the foregoing problems. The invention also provides a vehicle comprising the hub unit.

### SUMMARY OF THE INVENTION

The present invention provides an electrically movable wheel hub unit comprising a motor 9 composed of a stator 3 and a rotor 4, a planetary gear reduction mechanism 6 coupled to the rotor 4, a hub 7 enclosing the reduction mechanism 6 therein and having inner teeth 66a formed on an inner surface thereof and meshing with planetary gears 65, the hub 7 being rotatingly drivable by the rotation of the rotor 4, and a fixing support shaft 57 projecting outward from the hub 7 and rotatable relative to the hub 7 on an axis of rotation of the hub 7, the fixing support shaft 57 being provided singly and having at least one end projecting outward from the hub 7, the rotor 4 having a tubular rotating shaft 44 rotatably fitted around the fixing support shaft 57, the tubular rotating shaft 44 being provided with a sun gear 60 of the planetary gear reduction mechanism 6.

The axis of the rotor 4 will not deflect relative to the fixing support shaft 57 because the rotor shaft 44 is rotatably fitted around the single fixing support shaft 57 having at least one end projecting outward from the hub 7 as described above.

In the case where the fixing support shaft has opposite ends projecting outward from the respective opposite ends of the hub 7, the hub unit is more simplified in construction and easier to assemble than the conventional hub unit wherein the two fixing support shafts 57, 57a are separate from the rotor shaft 41.

### BRIEF DESCRIPTION OF THE DRAWINGS

FIG. 1 is a front view of an electrically assisted bicycle;

FIG. 2 is a sectional view of a hub unit;

FIG. 3 is a perspective view of the hub unit with a hub main body removed;

FIG. 4 is a perspective view of the hub unit;

FIG. 5 is an exploded perspective view of a stack of metal plates;

FIG. 6 is a sectional view of a hub unit of second embodiment;

FIG. 7 is a perspective view of the hub unit with a hub main body removed;

FIG. 8 is a sectional view of a conventional hub unit; and

FIG. 9 is a perspective view of the hub unit with a hub main body removed.

### DESCRIPTION OF THE PREFERRED EMBODIMENTS

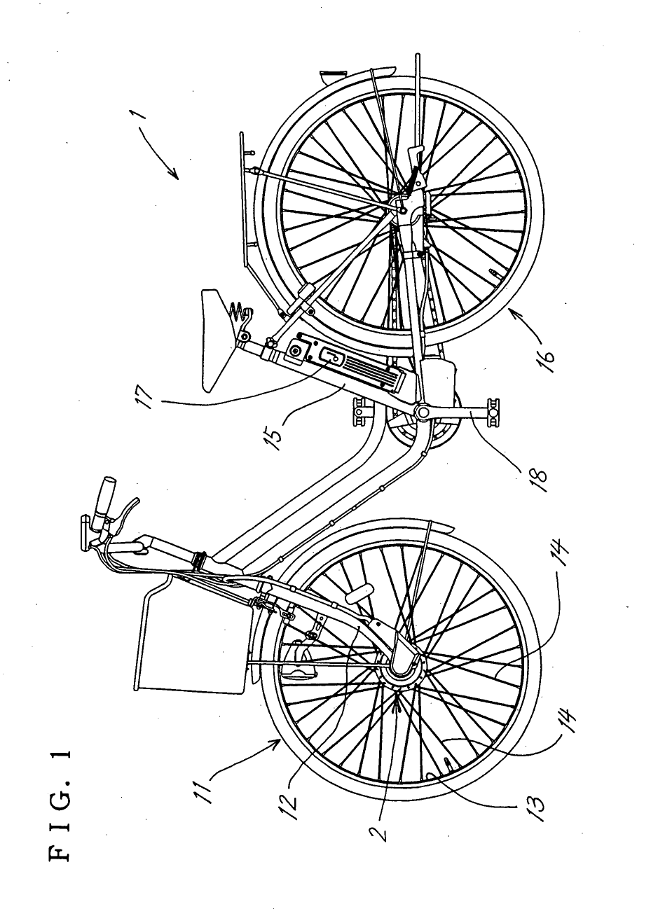

FIG. 1 shows an example of electrically assisted bicycle 1 having a hub unit 2 of the present invention.

A hub unit 2 is attached to the lower end of a front fork 12 of the bicycle 1, and the hub unit 2 and the rim 13 of a front wheel 11 are interconnected by spokes 14, 14.

A battery 17 is mounted on the bicycle between a seat post 15 and a rear wheel 16.

A sensor (not shown) is provided on a suitable portion on which the pedaling force of the pedals 18 acts for energizing a motor 9 of the hub unit 2 by the battery 17 when the load on the pedals is not smaller than a predetermined value.

The hub unit 2 has the above-mentioned motor 9 which comprises a stator 3 and a rotor 4, a hub 7 enclosing the motor 9 therein and rotatingly driven by the rotation of the rotor 4, and a fixing support shaft 57 secured to a motor housing, 5, projecting therefrom in alignment with the axis of rotation of the hub 7 and having opposite ends extending outward from the hub 7.

As shown in FIG. 5, the stator 3 comprises a stack 31 of a specified number of metal plates 31a blanked out and windings 32 provided around the metal plate stack 31. Each of the metal plates 31a is in the form of a ring having a plurality of T-shaped projections 31b arranged on the inner periphery of the ring at equal intervals circumferentially thereof and projecting toward the center of the ring. The metal plate 31a has twelve projections 31b according to the present embodiment.

The winding 32 is provided on a stack of projections 31b in phase as a unit.

Such a metal plate stack 31 is made conventionally by blanking out metal plates 31a from a metal sheet material with a blanking die and stacking the plates as blanked out at the same time.

For this reason, burrs created on respective adjacent pairs of blanked-out metal plates 31a, 31a are located at the same position or in alignment. If burrs are formed on each single blanked-out metal plate 31a uniformly circumferentially thereof, the metal plate stack 31 will have a uniform thickness circumferentially thereof.

However, this is almost unlikely in actuality; when a single blanked-out metal plate 31a is observed, burrs are not positioned uniformly with respect to the circumferential direction. When metal plates 31a which are blanked out in succession are merely stacked in superposed layers, the single metal plate stack 31 will have a difference of about 0.1 to 0.3 mm in thickness and has a portion of large thickness and a portion of small thickness.

For the reason to be given later, there is a need to reduce the likelihood that the metal plate stack 31 will have a portion of large thickness and a portion of small thickness. Accordingly, the stack 31 is divided into units 31c each comprising a number of blanked-out metal plates 31a, and the units 31c are stacked as displaced from one another through a predetermined angle.

According to the present embodiment, the units 31c are stacked as displaced from one another through an angle obtained by dividing 360 deg by the number of units 31c to make the metal plate stack 31. For example, in the case where the number of units 31c is three, the three units 31c are displaced from one another by 120 deg, and a wire is wound around each of the projection stacks 31b to form the winding 32.

The metal plate stack 31 can be made easily by blanking out metal plates 31a from a metal sheet material, stacking a specified number of blanked-out metal plates 31a upon blanking, rotating the metal sheet material through a predetermined angle, e.g., through 120 deg according to the present embodiment, within a horizontal plane every time the specified number of metal plates are blanked out.

Incidentally, the number of inward projections 31b on the metal plate 31b blanked out is limited to a number which can be divided by the number of units 31c.

The rotor 4 is rotatably disposed inside the stator 3 concentrically therewith.

The rotor 4 is made by inserting a tubular rotating shaft 44 through the center of a stack 42 of circular metal plates so as to render the shaft 44 rotatable with the metal plate stack 42.

A plurality of permanent magnets 43 are embedded in the outer peripheral portion of the metal plate stack 42 in parallel to the rotating shaft 44 at equal intervals with S poles and N poles arranged alternately circumferentially of the stack.

The housing 5 for the motor 9 is made by holding the metal plate stack 31 of the stator 3 between a pair of first and second end plates 51, 52 opposed to each other axially of the stator 3 and fastening the two end plates 51, 52 together with a plurality of bolts 53 inserted through the outer peripheral portion of the stack 31 and tightened up.

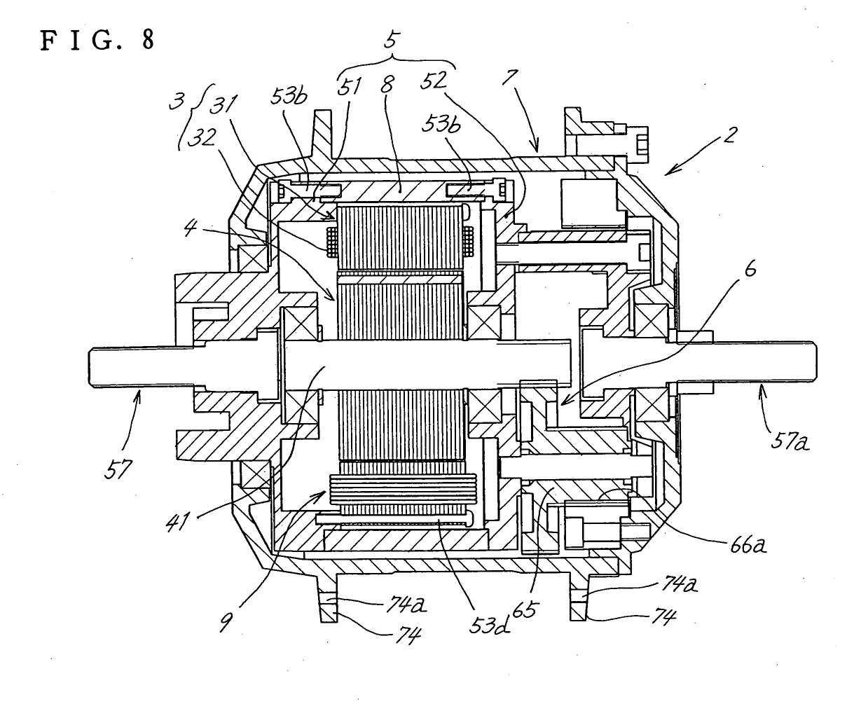

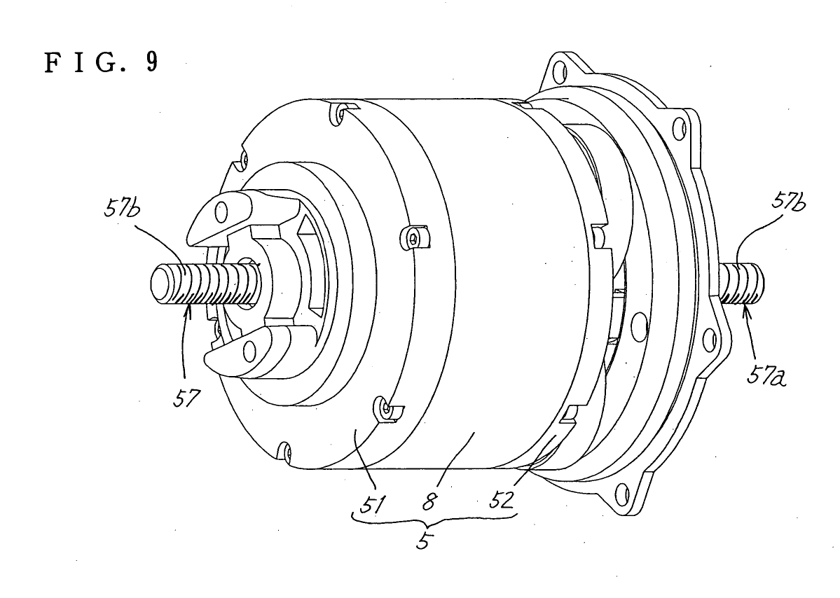

The metal plate stack 31 of the stator 3 serves the function of fixedly positioning the first end plate 51 and the second end plate 52 as spaced apart by a given distance. Thus, the metal plate stack 31 serves also the function of a cylindrical wall 8 of the motor housing 5 in the conventional hub unit shown in FIG. 8.

The first end plate 51 and the second end plate 52 are provided at their outer peripheral edges with short inward cylinder portions 54, 55, respectively. The short cylinder portions 54, 55 have at their inner ends respective stepped portions 54a, 55a having fitted therein opposite-end outer peripheral edges of the metal plate stack 31.

The rotating shaft 44 of the rotor 4 is tubular. The tubular rotating shaft 44 extends through the second end plate 52 to project outward beyond the second end plate 52. A bearing 49 is provided between the shaft 44 and the second end plate 52.

The first end plate 51 has a boss 56 projecting outward from its center.

The fixing support shaft 57 extends through and is secured to the first end plate 51 in alignment with the axis of the stator 3.

The support shaft 57 extends through the boss 56 of the first end plate 51, the tubular rotating shaft 44 of the rotor 4, the planetary gear reduction mechanism 6 to be described later and a closure plate 72 of the hub 7, and has opposite ends projecting outward from the hub 7. The opposite ends of the support shat 57 are externally threaded as at 57b for use in mounting the hub unit on the front fork 12 of the bicycle 1.

Bearings 46, 46 are provided between the tubular rotating shaft 44 of the rotor 4 and the fixing support shaft 57.

The reduction mechanism is provided externally of the second end plate 52 for transmitting the rotation of the tubular rotating shaft 44 of the rotor 4 upon a speed reduction.

The reduction mechanism of the present embodiment is a planetary gear reduction mechanism 6.

The reduction mechanism 6 has a planetary gear support frame 61 provided with three tubular legs 62 projecting toward and bearing against the second end plate 52 and equidistantly spaced circumferentially of the frame. The frame 61 is fastened to the second end plate 52 with bolts 63 extending through the respective legs 62.

Extending between and supported by the second end plate 52 and the planetary gear support frame 61 are three support shafts 64 equidistantly spaced circumferentially of the second end plate 52 and each adapted to rotatably support a planetary gear 65 thereon.

The planetary gear 65 comprises a large gear 65a positioned closer to the second end plate 52 and a small gear 65b positioned on the opposite side and coaxial with the gear 65a.

The large gear 65a of the planetary gear 65 is in mesh with a sun gear 60 formed on an end portion of the tubular rotating shaft 44 of the rotor 4. The small gear 65b of the planetary gear 65 is in mesh with inner teeth 66a on the closure plate 72 of the hub 7 to be described later.

The hub 7 comprises a hub main body 71 generally in the form of a cup which is open at the center of its bottom wall and open over the entire area of the other side, and the above-mentioned closure plate 72 covering the entire opening.

The hub main body 71 covers the motor housing 5 and the planetary gear reduction mechanism 6. A bearing 73 is provided in the bottom opening 70 around the boss 56 on the first end plate 51 of the motor housing S.

The closure plate 72 covers the entire opening of the hub main body 71 so as to conceal the support frame 61 of the reduction mechanism 6 and is fastened to the hub main body 71 with bolts 76.

Fastened with screws to the inner side of the closure plate 72 is an annular member 66 concentric with the fixing support shaft 57. The inner teeth 66a meshable with the planetary gears 65 are formed on the inner periphery of the annular member 66.

A bearing 75 is provided in the closure plate 72 around the fixing support shaft 57.

The hub main body 71 has a circumferential wall 74 formed on its outer peripheral surface and extending therearound at each of opposite side portions. Spoke attaching holes 74a are formed in the circumferential wall 74 and arranged at regular intervals circumferentially of the wall.

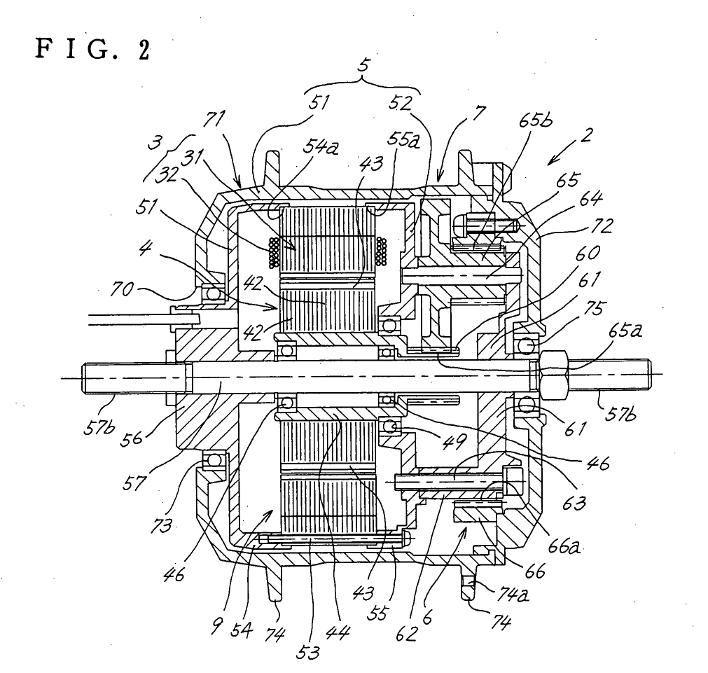

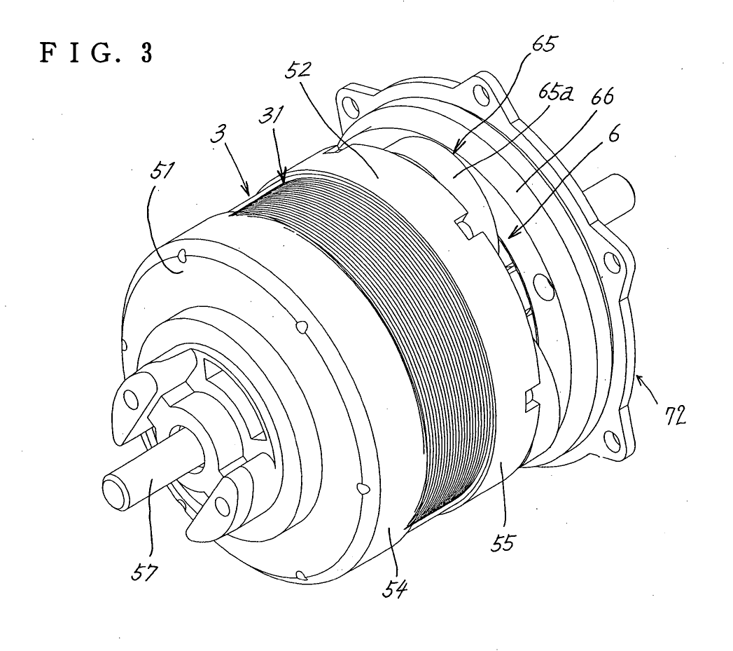

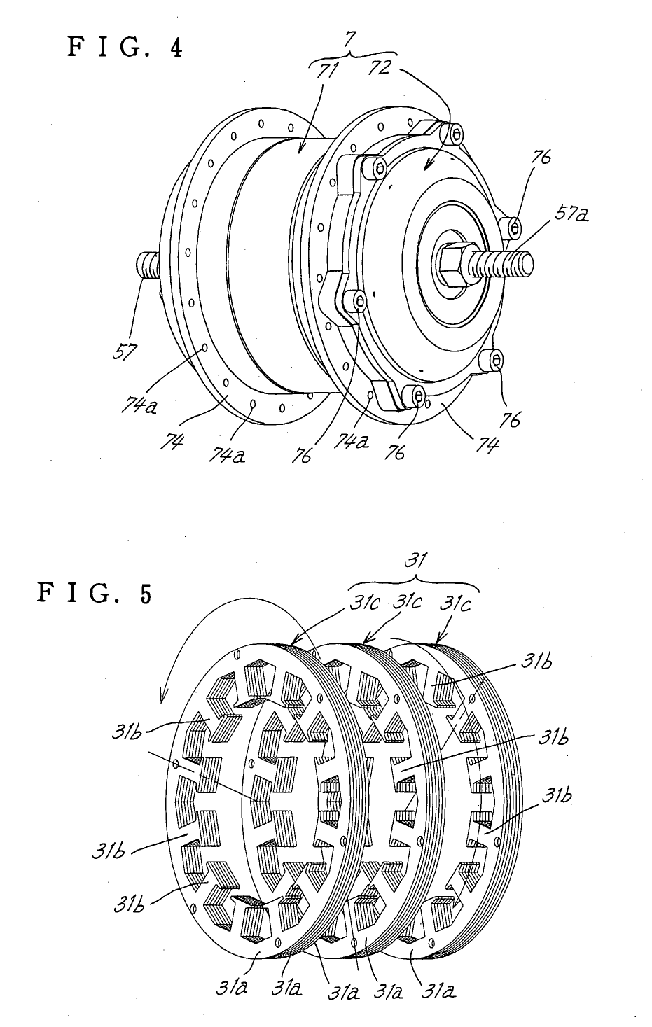

When the fixing support shaft 57 is secured to the front fork 12 of the bicycle by screw-thread engagement, the portions marked with lines slanting leftwardly downward in FIG. 2 are fixed portions, and the portions marked with lines slanting rightwardly downward are rotating portions.

When a load in excess of a specified value acts on the bicycle pedals 18 upon the pedals being stepped on, the battery 17 energizes the windings 32 of the stator 3, rotating the rotor 4.

The rotation of the rotor 4 rotates the sun gear 60 on the end of the tubular rotating shaft 44 to rotate the planetary gears 65 in position. The rotation of the planetary gears 65 is transmitted through the inner teeth 66a to the hub 7 on a speed reduction, drivingly rotating the front wheel 11.

By virtue of the rotation of the rotor 4, the bicycle 1 can be run with a reduced stepping force on the pedals 11.

Since the tubular rotating shaft 44 of the rotor 4 is rotatably fitted around the fixing support shaft 57 having opposite ends projecting from the hub 7, the axis of the rotor 4 will not deflect relative to the support shaft 57.

The hub unit is more simplified in construction and easier to assemble than the convention hub unit wherein the rotating shaft of the rotor is provided with two fixing support shafts arranged respectively on opposite sides thereof and separate from the rotating shaft.

The energization of the windings 32 causes the windings 32 to generate heat, which is given to the stator 3. In the case of the present embodiment, however, the motor housing does not have a tubular wall which prevents radiation of heat, so that the heat given to the stator 3 is released directly through opening between the pair of end plates 51, 52 holding the stator 3 therebetween, whereby the windings 32 can be prevented from overheating.

Because the cylindrical wall 8 of the motor housing 5 can be dispensed with, the hub unit can be manufactured at a lower cost and with a weight reduction corresponding to the wall 8.

Furthermore, the stator 3 can be increased in outside diameter by a value corresponding to the cylindrical wall omitted and therefore provides increased torque.

If the metal plate stack 31 of the stator 3 has varying thicknesses circumferentially thereof, the parallelism between the end plates 51, 52 involves errors, which produce a bending force acting on the rotating shaft 44 of the rotor 4 supported by bearings on the opposed end plates 51, 52, giving rise to the problem of causing trouble to the smooth rotation of the rotor 4. For this reason, an inherent problem will arise when the metal plate stack 31 of the stator 3 is held between the pair of end plates 51, 52 and if the end plates 51, 52 are fastened together by tightening up the bolts 53 so as to cause the thrust of screws to act on the stack 31 in the direction of stacking as practiced in the present embodiment.

According to the embodiment, however, a plurality of units 31c each comprising a specified number of metal plates 31a blanked out are stacked as displaced from one another by a predetermined angle so as to render the metal plate stack 31 uniform in thickness circumferentially thereof to the greatest possible extent. Even if the end plates 51, 52 are fastened by tightening up the bolts 53 so as to causes the thrust of screws to act on the metal plate stack 31 in the stacking direction, the first and second end plates 51, 52 can therefore be given parallelism with high accuracy.

Consequently, the rotor 4 can be rotated smoothly by giving improved parallelism to the bearings for supporting the opposite ends of the rotating shaft 44 of the rotor 4.

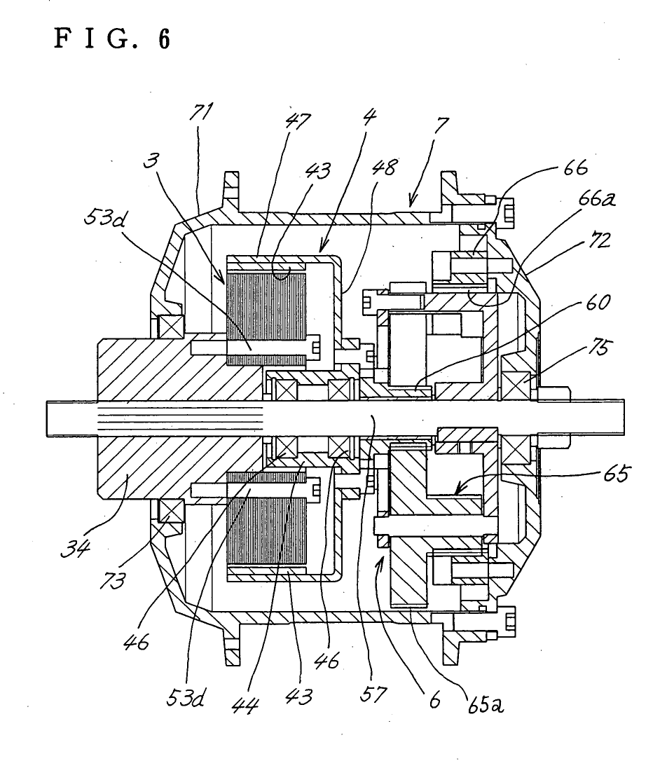

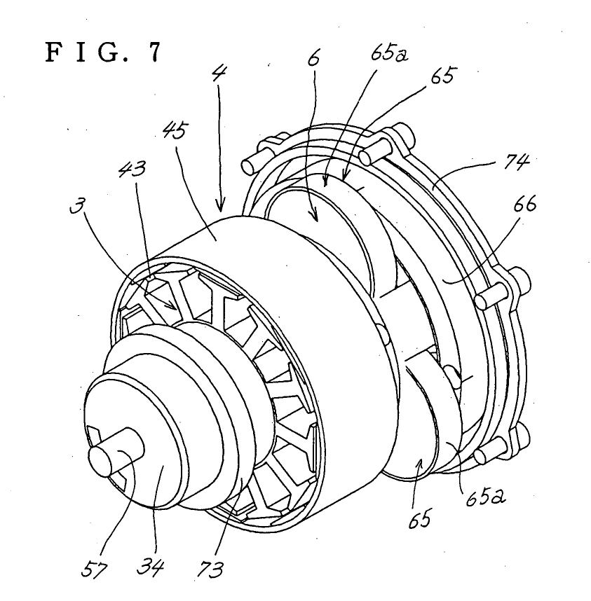

FIG. 6 shows an embodiment of hub unit 2 comprising a motor 9 having a rotor 4 of the outer type. FIG. 7 is a perspective view of the hub unit 2 with a hub main body 71 removed.

A fixing support shaft 57 is disposed on the axis of a hub 7 rotatably relative to the hub 7. The support shaft 57 has one end extending through and secured to a tubular block 34, and the other end extending through a bearing 75 provided in the center of a closure plate 72 of the hub main body 71 and projecting outward from the hub 7.

The motor 9 has a stator 3 fastened to the inner end of the block 34 with bolts 53d.

The rotor 4 of the motor 9 comprises a cylinder 47 provided around the stator 3, a tubular rotating shaft 44 rotatably fitting around the support shaft 57 and having fixed thereto an end plate 48 at one end of the cylinder 47, and permanent magnets 43 provided on the inner surface of the cylinder 47 with N poles and S poles arranged alternately circumferentially of the cylinder 47.

A sun gear 60 mounted on one end of the tubular rotating shaft 44 operates a planetary gear reduction mechanism 6, and the rotation of planetary gears 65 is transmitted to inner teeth 66a of the hub 7 upon a speed reduction to rotate the hub 7 at a reduced speed in the same manner as in the hub unit 2 shown in FIG. 2.

In the case of the hub unit 2 shown in FIG. 6, the motor housing 5 can be dispensed with, while the rotor 4 can be of reduced weight to further reduce the weight of the hub unit 2.

The hub unit 2 of the present invention, which is useful for electrically assisted bicycles, can be embodied alternatively for hubs for vehicles having wheels, for example, for wheelchairs.

According to the first and second embodiments described, the fixing support shaft 57 extends outward from opposite ends of the hub 7 so as to support the hub unit 2 at its opposite ends, whereas when the hub unit 2 is to be supported at only one end thereof as in wheelchairs, one end of the fixing support shaft 57 needs only to be projected outward from the hub 7.

Apparently, the present invention can be modified and altered by one skilled in the art without departing from the spirit of the invention, and such modification is included within the scope of the invention as set forth in the appended claims.

1. An electrically movable wheel hub unit comprising a motor composed of a stator and a rotor, a planetary gear reduction mechanism coupled to the rotor, a hub enclosing the motor and the reduction mechanism therein and having inner teeth formed on an inner surface thereof and meshing with planetary gears, the hub being rotatingly drivable by the rotation of the rotor, and a fixing support shaft rotatable relative to the hub on an axis of rotation of the hub,
the fixing support shaft being provided singly and having at least one end projecting outward from the hub, the rotor having a tubular rotating shaft rotatably fitted around the fixing support shaft, the tubular rotating shaft being provided with a sun gear of the planetary gear reduction mechanism.

2. The electrically movable wheel hub unit according to claim 1 wherein the rotor is of the outer type comprising permanent magnets arranged around an outer peripheral surface of the stator.

3. The electrically movable wheel hub unit according to claim 1 wherein a pair of end plates are opposed to each other with a stack of metal plates of the stator held therebetween and with the fixing support shaft extending therethrough, the pair of end plates being fastened together with bolts to clamp the metal plate stack therebetween, one of the end plates being fixedly mounted on the support shaft, the stator having an outer peripheral surface left exposed to face an inner surface of the hub between the end plates.

4. The electrically movable wheel hub unit according to claim 3 wherein the metal plate stack comprises units each having a specified number of metal plates blanked out, and the units are stacked as displaced from one another in the direction of rotation by a predetermined angle.

5. A vehicle comprising a wheel having incorporated therein an electrically movable wheel hub unit according to any one of claims 1.

6. A vehicle comprising a wheel having incorporated therein an electrically movable wheel hub unit according to any one of claim 2.

7. A vehicle comprising a wheel having incorporated therein an electrically movable wheel hub unit according to any one of claims 3.

8. A vehicle comprising a wheel having incorporated therein an electrically movable wheel hub unit according to any one of claim 4.
